(19) United States
(12) Patent Application Publication
(10) Pub. No.: US 2024/0321018 A1
(43) Pub. Date: Sep. 26, 2024

(54) METHOD/SYSTEM/COMPUTER PROGRAM FOR BSM/RTCM/SCMS ENABLED GROUND TRUTH RUN TIME PERCEPTION

(71) Applicant: Sonamore, Inc. dba P3Mobility, Ann Arbor, MI (US)

(72) Inventors: Martin Daniel Nathanson, Westmount (CA); Andrew Gilbert Miller, Pittsburgh, PA (US)

(21) Appl. No.: 18/612,114

(22) Filed: Mar. 21, 2024

Related U.S. Application Data
(60) Provisional application No. 63/453,592, filed on Mar. 21, 2023.

(51) Int. Cl. G07C 5/00; G01C 21/00; G06F 21/60

(52) U.S. Cl. CPC G07C 5/008; G01C 21/3885; G06F 21/602

(57) ABSTRACT

Provided a Road Side Unit (RSU) transceiver or a vehicle mounted On Board Unit (OBU) transceiver enabled to receive authenticated participant SAE J2735 Basic Safety Messages, RTK corrected GNSS positioning data, and equipped with a sensor suite consisting of one or more electro-optical sensors, camera sensors, thermal imaging sensors, lidar sensors, ultrasonic sensors, GNSS receiver, and or radar sensors; the system may include one or more processors programmed or configured to receive data from the system's own sensor suite, reporting transceivers and other network connected devices, to construct ground truth object detection, classification, and tracking messages for the object-actors in the system's field of view.

### CROSS-REFERENCE TO RELATED APPLICATIONS

The present application claims priority to U.S. provisional patent application No. 63/453,592, filed on Mar. 21, 2023, the contents of which are hereby incorporated by reference.

### TECHNICAL FIELD

The disclosed subject matter relates generally to methods, systems, and products for human and computer control of vehicles operating in vicinity of road areas, the training of vehicle control system machine learning and/or perception systems, and the development, validation, and verification of vehicle control systems prior (e.g., simulation), during, and following road operation.

### BACKGROUND

The premise of the present disclosure is that cooperative awareness messages (BSMs in North America/CAMs in Europe) can be used as a basis to establish ground truth for perception systems' processes. As such, the deviation of position, as reported by sensors, from the RTK-corrected position reported in cooperative awareness messages, is an accurate, quantifiable measure of ground truth that can be used to develop, train, validate perception systems a priori, verify and check perception systems at runtime, conduct performance measurement post run, and can be used as a pre-cursor parameter set on which to determine the confidence level of perception systems' outputs.

Practitioners in the field have envisioned that V2X-based cooperative awareness provides a means of augmenting the process of sensor-based perception and object detection. This approach treats BSMs/CAMs as additional inputs to the perceived environment model; but this approach does not incorporate objective ground truth in the run time perception process for downstream system use. The prevalent treatment or use of the idea of cooperative awareness is that the BSMs/CAMs broadcast by object-actors can serve either to widen the perception model of the receiver beyond the field-of-view, or to increase the accuracy and reliability of sensor-based object actor detection reports by fusing them with the BSMs/CAMs; but again this is not the same as direct establishment and incorporation of objective ground truth.

A mainstream employed methodology for ML/CV (Machine Learning/Computer Vision) perception model set training and validation in industry and academia requires a priori labeled data on large datasets. First a large data corpus must be captured that is representative of the static environment, the variable environmental factors and conditions, and the variable type and instances of object-actors residing or moving through the environment. As is, many state-of-the-art ML/CV perception systems require offline, post capture labeling; and this labeling task is often achieved by tedious and costly human manual annotation on sensor captured frames. In addition to run-time ground truth establishment, the system described below alleviates the offline, post-run human labeling requirement inherent to the state-of-the-art ML/CV perception systems.

Current practice for ML/CV based cooperative perception is to develop awareness of object-actors through consensus. Consensus is established through varying processes to corroborate two or more participants' independent reports of their respective perception outputs of the object-actors in their field of view. Per SAE J3224, participants should be reporting the confidence on various data fields they share; however, there is no widely adopted industry standard for establishing confidence on machine learning/computer vision inferenced perception. Current industry and academic practice to establish a confidence level may rely on some form of measuring the variances or marginal differences inherent to the contributing object-actor reports used to produce consensus. Absent is the incorporation of objective ground truth and the use of ground truth to establish high confidence perception as well as confidence measurement on perception outputs.

Establishing Ground Truth is a requirement to higher order capabilities and downstream processes in automotive assistance and automation technologies. The system described below establishes ground truth and makes it available across the sensor data capture used in a system's perception process.

### Ground Truth:

Ground Truth is the term to describe information known to be real or true by direct observation and measurement. ADAS/ADS perception systems require ground truth data for the development of perception models and to operate with high confidence when ground truth can be provided during runtime operation. Perception models are trained and validated by providing ground truth sensor data where the object-actors are detected and classified a priori. During live runtime operation, perception models reconcile the runtime sensor data based predictions with runtime known position, classification-type, and spatial geometry data based on BSM/CAM messages to establish ground truth on object-actors in the operating environment.

### Basic Safety Messages/Cooperative Awareness Messages:

SAE J2735 Basic Safety Message (BSM) or the European equivalent Cooperative Awareness Message (CAM) is a standardized data object encapsulated in abstract syntax notation-based message format transacted to provide situational awareness in the road operating environment. The RSU/OBU ecosystem receives Real Time Kinematic GNSS positioning updates to ensure that systems are localizing with accurate global coordinates for use in their position reporting.

Situational awareness information data shared in BSMs/CAMs include a self-report of a vehicle's state 10 times a second (10 Hz) that includes data attributes for latitude, longitude, elevation, speed, heading, steering wheel angle, acceleration, brake system status, and vehicle length and width size. BSM/CAM information digested by Advanced Driver Assistance Systems (ADAS) and/or Automated Driving Systems (ADS) enables augmented road situational awareness, beyond line-of-sight awareness and forewarning, and higher confidence object perception processes accounting for third party vehicles and infrastructure reporting their respective objective coordinate locations and dimensions. The benefits of this augmented awareness are improved safety outcomes and more efficient vehicle travel.

BSMs/CAMs are transacted in a one-to-many (broadcast) mode via, but not limited to, V2X wireless communication protocols such as IEEE 1609, aka Wireless Access Vehicular Environment (WAVE), with the medium access control (MAC) layer being IEEE 802.11p, or PC5 (i.e., C-V2X). BSMs/CAMs may be shared in both peer to peer or “vehicle to vehicle” (V2V) or vehicle to infrastructure (V2I) and extension of V2I is vehicle-to-network (V2N). The communications ecosystem for V2V, V2I, and V2N is generally referred to as Vehicle-to-Everything or “V2X”.

To exchange BSM/CAMs, participant vehicles are equipped with a radio frequency transceiver modem referred to as an Onboard Unit (OBU). A fixed infrastructure radio frequency transceiver is referred to as Roadside Unit (RSU). The IEEE 1609.2 component of the WAVE stack ensures the security and authentication of data transacted in the ecosystem, using SCMS certificates (i.e., “credentials”), thereby enabling RSU/OBU units to determine the trustworthiness of the BSM/CAM sender and by extension its messages. Devices compliant with IEEE 1609.2 and provisioned with SCMS credentials, i.e., RSUs and OBUs, are called End Entities (EEs).

### Security Credential Management System (SCMS):

SCMS is an instantiation of a public key infrastructure (PKI) which generates and delivers certificates to EEs to provide trust and assurance for messages which they broadcast, SAE J3275 and SAE J3224 messages encapsulating sensor data aimed at on-board ADAS/ADS. SCMS can revoke credentials where trust cannot be established or maintained. Each EE participant receives SCMS credentials that are used to sign issued messages and be read by recipients to establish the trustworthiness of the message's reporting source. The SCMS system enables EEs to incorporate BSMs/CAMs and Sensor Data Sharing Messages (SDSM) into their operating pictures with increased trust than otherwise available from non-credentialed messaging.

### SUMMARY

Accordingly, it is an object of the presently disclosed subject matter to provide methods, system, and computer program products for establishing ground truth perception outputs on object-actors with use of BSMs/CAMs, RTK corrected GNSS positioning data, and sensor data. The methods, system, and computer program may reside on a host base system; this host base system serves as the physical platform for sensors and compute that outputs sensor data of the sensed road environment in the vicinity of the host system.

These advantages and others are achieved, for example, by a system including one or more processors programmed or configured (i) to receive data associated with road environment object-actor sensor based detection and classification predictions and IEEE 1609 standard Security Credential Management System (SCMS) cryptographically signed SAE J2735 standard Basic Safety Messages (BSM) and/or Cooperative Awareness Messages (CAM), and (ii) to determine run-time ground truth perception based on reconciled and matched data artifacts constructed in a system relative coordinate reference map associated from BSM/CAM reported object-actor data and predicted object-actors data artifacts.

When determining run-time ground truth perception, the one or more processors are further programmed and configured (iii) to extract object-actor associated data in the received SCMS cryptographically signed SAE J2735 participant broadcasted Basic Safety Messages/Cooperative Awareness Messages from which an object-actor's pose is determined, wherein the received data includes but is not limited to a reported object-actor's real-time kinematic GNSS corrected position, spatial dimensions (e.g. length×width×height) and the categorical-type classification of the object-actor, wherein the BSM/CAM extracted data is transformed into a format to store and retrieve the represented object-actor as an artifact within a system relative coordinate reference map, (iv) to construct representative object-actor artifacts within a system relative coordinate reference map, wherein a coordinate system comprises a data structure wherein persistent and/or temporary data representing road environment features and object-actors are related to the host base system in a format of normalized reference units of measure related to the sensing system's current position and/or a frame of reference, wherein the object-actors represented in the reference map are data artifacts generated from either sensor based predicted perception associated output data or from BSM/CAM based message data which contain position and occupancy attributes normalized with respect to the base system reference coordinate system, wherein in addition to the object-actor artifacts applicable a priori and/or run-time mapped and sensed road environmental features are also represented, (v) to predict object-actors present within the fields of view of the one or more sensors of the system; wherein the output of prediction comprises predicted presence of object-actors and respective classification and position state associated with sensor data, wherein the received sensor data is associated with one or more camera, LIDAR, or RADAR sensor, and wherein the prediction is based on the output of one or more machine learning models that predict the presence, position, category-type, and geometric dimensions of an object-actor, wherein the predicted object-actor output is sent to the system relative coordinate reference map as predicted object-actor artifact, (vi) to determine the existence of two or more artifacts loaded in the system relative coordinate reference map that correspond to the same object-actor in the road environment, where a minimum of one of the two more artifacts is associated with BSM/CAM data upon which one or more algorithms and or machine learning models establishes the existence of a match between two or more object-actor representative artifacts, wherein a matched set of artifacts constitutes a ground truth object-actor in the system reference map, when no sensor associated object-actor artifacts are identified as a match to a BSM/CAM artifact an unmatched BSM/CAM is the basis for constituting a ground truth perception object-actor, wherein after the determined ground truth object-actor artifact is constructed the precursor artifacts used to make the match are removed from the reference map, the outcome of the matched artifacts and map update is run-time ground truth perception, wherein the system relative coordinate reference map updates to reflect the outcome state for subsequent system runtime use and/or external transmission of ground truth data, and (vii) to persist the matched object-actors artifacts as ground truth object-actor data artifacts in the system relative coordinate map which subsequently are logged with cross-matched and reconciled data associated with Basic Safety Messages/Cooperative Awareness Messages and road environment sensor-perception data.

The one or more processors may be further programmed or configured to determine the ground truth velocity of an object-actor based on proceeding established run-time ground truth perception data in series. The one or more processors may be further programmed or configured to determine the ground truth acceleration of an object-actor based on proceeding established run-time ground truth perception data in series. The one or more processors may be further programmed or configured to construct labeled data for the post run training of machine learning models, wherein the run-time determined ground truth perception data and the raw data from the system's one or more sensors are logged and timestamped, wherein the logged and timestamped ground truth perception data generated at run-time comprises labeled features associated to the logged sensor data.

These advantages and others are also achieved, for example, by a method including (i) receiving data associated with road environment object-actor sensor based detection and classification predictions and IEEE 1609 standard Security Credential Management System (SCMS) cryptographically signed SAE J2735 standard Basic Safety Messages (BSM) and/or Cooperative Awareness Messages (CAM), and (ii) determining run-time ground truth perception based on reconciled and matched data artifacts constructed in a system relative coordinate reference map associated from BSM/CAM reported object-actor data and predicted object-actors data artifacts.

When determining run-time ground truth perception, the method further includes (iii) extracting object-actor associated data in the received SCMS cryptographically signed SAE J2735 participant broadcasted Basic Safety Messages/Cooperative Awareness Messages from which an object-actor's pose is determined, wherein the received data includes but is not limited to of a a reported object-actor's real-time kinematic GNSS corrected position, spatial dimensions (e.g. length×width×height), and the categorical-type classification of the object-actor, wherein the BSM/CAM extracted data is transformed into a format to store and retrieve the represented object-actor as an artifact within a system relative coordinate reference map, (iv) constructing representative object-actor artifacts within a system relative coordinate reference map, wherein a coordinate system comprises a data structure wherein persistent and/or temporary data representing road environment features and object-actors are related to the host base system in a format of normalized reference units of measure related to the sensing system's current position and/or a frame of reference, wherein the object-actors represented in the reference map are data artifacts generated from either sensor based predicted perception associated output data or from BSM/CAM based message data which contain position and occupancy attributes normalized with respect to the base system reference coordinate system, wherein in addition to the object-actor artifacts applicable a priori and/or run-time mapped and sensed road environmental features are also represented, (v) predicting object-actors present within the fields of view of the one or more sensors of the system; wherein the output of prediction comprises predicted presence of object-actors and respective classification and position state associated with sensor data, wherein the received sensor data is associated with one or more camera, LIDAR, or RADAR sensor, and wherein the prediction is based on the output of one or more machine learning models that predict the presence, position, category-type, and geometric dimensions of an object-actor, wherein the predicted object-actor output is sent to the system relative coordinate reference map as an predicted object-actor artifact, (vi) determining the existence of two or more artifacts loaded in the system relative coordinate reference map that correspond to the same object-actor in the road environment, where a minimum of one of the two more artifacts is associated with BSM/CAM data upon which one or more algorithms and or machine learning models establishes the existence of a match between two or more object-actor representative artifacts, wherein a matched set of artifacts is constitutes a ground truth object-actor in the system reference map, when no sensor associated object-actor artifacts are identified as a match to a BSM/CAM artifact an unmatched BSM/CAM is the basis for constituting a ground truth perception object-actor, wherein after the determined ground truth object-actor artifact is constructed the precursor artifacts used to make the match are removed from the reference map, the outcome of the matched artifacts and map update is run-time ground truth perception, wherein the system relative coordinate reference map updates to reflect the outcome state for subsequent system runtime use and/or external transmission of ground truth data, and (vii) persisting the matched object-actors artifacts as ground truth object-actor data artifacts in the system relative coordinate map which subsequently are logged with the associated data as cross-matched and reconciled data associated with Basic Safety Messages/Cooperative Awareness Messages and road environment sensor-perception data.

These advantages and others are further achieved, for example, by at least one non-transitory computer readable medium storing at least one computer program product that comprises one or more instructions that cause at least one processor to perform the method steps described above.

### BRIEF DESCRIPTION OF THE DRAWINGS

The preferred embodiments described herein and illustrated by the drawings hereinafter are included to illustrate and not to limit the invention, where like designations denote like elements.

FIG. 1 shows a non-limiting illustrative system overview.

### DETAILED DESCRIPTION

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure, which is defined by the claims. It is also to be understood that the drawings included herewith only provide diagrammatic representations of the presently preferred structures of the present invention and that structures falling within the scope of the present invention may include structures different than those shown in the drawings.

The disclosed invention provides a method, system, and computer program products for establishing ground truth perception outputs on object-actors with use of BSMs/CAMs, RTK corrected GNSS positioning data, and sensor data. The methods, system, and computer program may reside on a host base system; this host base system serves as the physical platform for sensors and compute that outputs sensor data of the sensed road environment in the vicinity of the host system.

The system uses BSMs/CAMs as known object-actors with known position, categorical-type classification, and spatial dimensions (e.g., object type: Vehicle-SUV; geometry box dimensions: width 2.2 meters, height 2.3 meters, length 4.2 meters; Position: latitude 32.553385°, longitude −96.822104°, elevation 197.815 meters). The BSM/CAM report is transformed into a formatted data artifact to place the known object-actor on the system referential coordinate system map. The known object-actor is cross-matched to the system perception module output artifacts concurrently populated on the system referential coordinate system map. The system may make use of these cross matches to establish ground truth on its internal perception system as well as use in offline ML (machine-learning) model/algorithm training refinement. A feedback loop of the crossmatches enables reviewers to assess the performance of the system's perception system and aid further refinements in the perception task. Beyond establishing runtime and offline training data with ground truth, system users also may use the cross-matched object-actor data to train high confidence model sets/algorithms to detect, classify and track object-actors who do not report BSMs/CAMs.

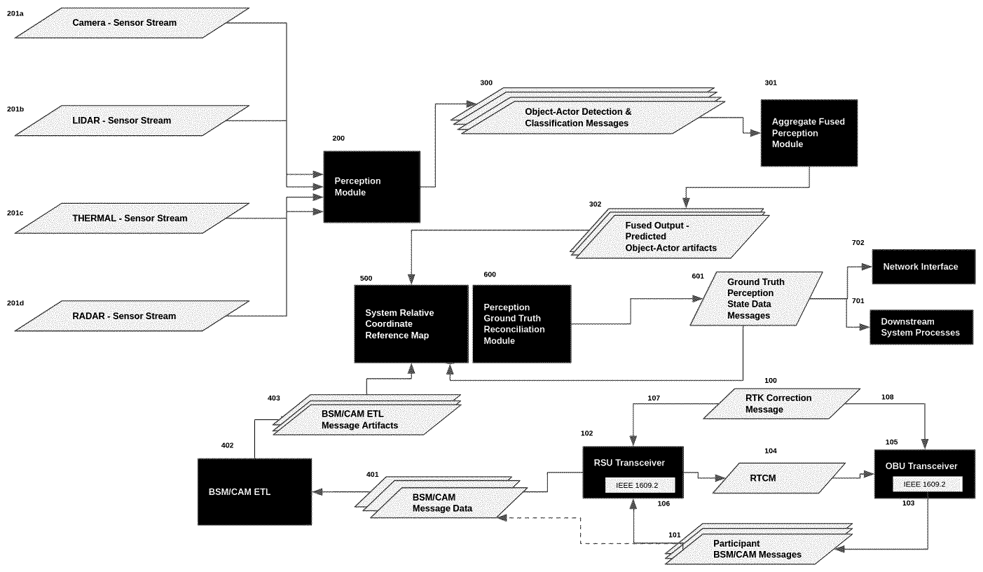

With reference to FIG. 1, shown is a non-limiting illustrative system overview. RSUs are equipped either with 107 a direct RTK receiver or RTK correction updates via a network interface that sends RTK corrections to the RSU. The system receives Real Time Kinematic positioning (RTK) error corrections 100 to global navigation satellite systems (GNSS) positioning. The RTK correction updates provide high accuracy on position data, which the RSU transceiver 102 may transform into SAE J2735 RTCM (Radio Technical Commission for Maritime Services) messages 104 to be broadcast in the ecosystem and used by OBU 105 to apply corrections to the position data in their BSMs/CAMs. Alternatively, OBU 105 equipped with RF receiver 108 may acquire the RTK correction 100 directly.

The IEEE 1609.2 module 103 incorporated in OBU 105 uses SCMS credentials to sign outgoing BSMs/CAMs. The equivalent module 106 in RSU 102 validates received BSMs/CAMs. This ensures that only reported BSMs/CAMs from authenticated participants are deemed trustworthy, thereby preventing rogue participants from providing erroneous data to the system and provides assurance over the integrity of the BSM/CAM data and follow-on system broadcast or messages to shared perception participants.

The system RSU/OBU radio transceiver module 102 receives BSMs/CAMs 101 from reporting participants and the IEEE 1609.2 module 106 validates the message before passing the message data to the BSM/CAM Extract, Transform and Load (ETL) module 402. The BSM/CAM ETL module 402 extracts the incoming BSM/CAM data and transforms the provided position data into an data artifact that includes but is not limited to system coordinates, classification, and occupancy geometry messages 403 to be placed into the system relative coordinate reference map 500. Whereupon with the BSM/CAM associated data artifacts, concurrently generated predictions of object-actors' states may be compared, reconciled, and matched to further enable, reconcile, confirm and/or augment perception, prediction and/or motion planning processes.

The system relative coordinate reference map 500 comprises a data structure wherein persistent and/or temporary data artifacts representing object-actors and other data items representing road environment features are related to the host base system in a format of normalized reference units of measure related to the sensing system's current position and/or a frame of reference. The map 500 hosts runtime generated artifacts representing either the predicted object-actor or BSM/CAM reported object-actors respectively from the system perception processes in the perception module 200 and aggregate fused perception module 300 and the BSM/CAM ETL module 402. The generated artifacts contain position and occupancy attributes normalized with respect to the base system reference coordinate system contained in the map. In some non-limiting embodiments, the map also may host a priori determined and/or run-time mapped and sensed road environmental features.

The system's perception module 200 performs runtime detection and classification tasks to determine the presence of discrete object-actor(s) in a sensor's field of view, classify the object-actors' categorical-type, and determine the position of the object-actor in relation to the sensor's data frame.

The system's perception module 200 may receive sensor input from one or more of the following types of sensors, but not limited to, camera 201a, LIDAR 201b, thermal 201c RADAR 201d. Following any pre-processing and formatting data handling procedures, the system's perception module 200 performs object detection and classification tasks to extract distinct object-actor entities from the sensor data. The module's 200 output Object-Actor Detection and Classification Messages 300 describe an object-actor's classification type and inferred detected locations and spatial occupancy. The Object-Actor Detection and Classification Messages becomes the data associated with a predicted object-actor data artifact that is transmitted downstream to a system relative coordinate reference map, in some non-limited embodiments the outputs of sensor specific perception modules are sent to intermediate perception aggregation process modules 301. The messages 300 are sent to the Aggregate Fused Stream Perception Module 301 which cross compares the multiple sensor model outputs to determine an aggregate classification-detection determination based on the fidelity and confidence level of each streamed sensors independent model output and determining a multiple sensor reinforced classification and detection determination. The Aggregate Fused Stream Perception Module sends Fused Output-Predicted Object-Actor artifact 302 messages to the system relative coordinate reference map 500, within which the fused output messages are accordingly referred to as predicted object-actor artifacts.

The system's Perception Ground Truth Reconciliation Module 600 processes both BSMs/CAMs derived object-actors artifact data 601 and the perception fused output reports of predicted object-actor artifacts 302 which both reside within the system relative coordinate reference map.

The module 600 computes crossmatches between the two different data set artifacts (BSM/CAM reports vs Predicted object-actor perception process) by geometry, category-type classification, and pose and tracked pose over the course of multiple sequential sample periods. Accordingly pose is defined as an object-actor's position, velocity (speed and direction of motion), and spatial occupancy with respect to the system relative coordinate system constituting the base of the reference map 500. The module conducts concurrent reconciliation processes of two more artifacts with respect to classification, position, pose, and tracked pose criteria. A match establishes which sensor detected object-actors artifacts are the same object-actor in known BSM/CAM message report associated object-actors artifacts. Reconciling with a match of the two different data set artifacts on an object-actor produces ground truth and relates the system's own pose with BSM/CAM reported object-actors and the system's determined predicted object-actors associated with sensor data. The resulting output being established ground truth on specific object-actors with which the system can include in subsequent tasks. The output of a matched object-actor from the reconciliation between BSM/CAM and predicted object-actor artifacts within the system relative coordinate reference map is ground truth for the system's perception system. In the absence of a corresponding predicted object-actor artifact, where and when a BSM/CAM based artifact exists, the BSM/CAM artifact is the basis for the ground truth report output as transformed to the coordinates relevant to the system on the system relative coordinate reference map.

The Perception Ground Truth Reconciliation Module updates the System Relative Coordinate Reference Map with a reconciled ground truth data messages 601 to other system downstream processes 701 or network interfaces 702 for sending to external systems, as well as updating the system relative coordinate reference map with the ground truth object-actor data artifacts with which to further perform runtime object-actor tracking and reconciliation. Downstream System Processes 701 conduct object-actor tracking in relation to the System Referential Coordinate Reference Map and the reconciled object-actor determined by the Perception Ground Truth Reconciliation Module 600. Tracking is the process and corresponding output of determining the current position, velocity, and acceleration of a detected object-actor over a sequence of artifact and reconciliation updates. The perception ground truth reconciliation module by relating sequential ground truth determination outputs determines the change in position and heading of a ground truth object-actor this is ground truth of the object-actors velocity in relation to the system relative coordinate referential map. Additionally with sequential determinations of object-actor position and velocity ground truth outputs, the reconciliation module determines the change in position and velocity to determine the ground-truth acceleration of an object-actor. The Reconciliation Module 600 additionally writes the established ground truth positional, geometric occupancy, velocity, and acceleration information as timestamped output to persistent logs. The corresponding timestamped sensor data is persisted and the ground truth data is annotated as feature labels associated with the logged sensor data.

Since many modifications, variations, and changes in detail can be made to the described preferred embodiments of the invention, it is intended that all matters in the foregoing description and shown in the accompanying drawings be interpreted as illustrative and not in a limiting sense. Consequently, the scope of the invention should be determined by the appended claims and their legal equivalents.

What is claimed is:

1. A system comprising:
one or more processors programmed or configured to:
receive data associated with road environment object-actor sensor based detection and classification predictions and IEEE 1609 standard Security Credential Management System (SCMS) cryptographically signed SAE J2735 standard Basic Safety Messages (BSM) and/or Cooperative Awareness Messages (CAM); and
determine run-time ground truth perception based on reconciled and matched data artifacts constructed in a system relative coordinate reference map associated from BSM/CAM reported object-actor data and predicted object-actors data artifacts,
wherein for the determining run-time ground truth perception, the one or more processors are further programmed and configured to:
extract object-actor associated data in the received SCMS cryptographically signed SAE J2735 participant broadcasted Basic Safety Messages/Cooperative Awareness Messages from which an object-actor's pose is determined, wherein the received data includes but is not limited to a reported object-actor's real-time kinematic GNSS corrected position, spatial dimensions, including a length, a width, and/or a height, and the categorical-type classification of the object-actor, wherein the BSM/CAM extracted data is transformed into a format to store and retrieve the represented object-actor as an artifact within a system relative coordinate reference map;
construct representative object-actor artifacts within a system relative coordinate reference map, wherein a coordinate system comprises a data structure wherein persistent and/or temporary data representing road environment features and object-actors are related to the host base system in a format of normalized reference units of measure related to the sensing system's current position and/or a frame of reference, wherein the object-actors represented in the reference map are data artifacts generated from either sensor based predicted perception associated output data or from BSM/CAM based message data which contain position and occupancy attributes normalized with respect to the base system reference coordinate system, wherein in addition to the object-actor artifacts applicable a priori and/or run-time mapped and sensed road environmental features are also represented;
predict object-actors present within the fields of view of the one or more sensors of the system; wherein the output of prediction comprises predicted presence of object-actors and respective classification and position state associated with sensor data, wherein the received sensor data is associated with one or more camera, LIDAR, or RADAR sensor, and wherein the prediction is based on the output of one or more machine learning models that predict the presence, position, category-type, and geometric dimensions of an object-actor, wherein the predicted object-actor output is sent to the system relative coordinate reference map as predicted object-actor artifact;
determine the existence of two or more artifacts loaded in the system relative coordinate reference map that correspond to the same object-actor in the road environment, where a minimum of one of the two more artifacts is associated with BSM/CAM data upon which one or more algorithms and or machine learning models establishes the existence of a match between two or more object-actor representative artifacts,
wherein a matched set of artifacts constitutes a ground truth object-actor in the system reference map, when no sensor associated object-actor artifacts are identified as a match to a BSM/CAM artifact an unmatched BSM/CAM is the basis for constituting a ground truth perception object-actor, wherein after the determined ground truth object-actor artifact is constructed the precursor artifacts used to make the match are removed from the reference map, the outcome of the matched artifacts and map update is run-time ground truth perception, wherein the system relative coordinate reference map updates to reflect the outcome state for subsequent system runtime use and/or external transmission of ground truth data; and
persist the matched object-actors artifacts as ground truth object-actor data artifacts in the system relative coordinate map which subsequently are logged with cross-matched and reconciled data associated with Basic Safety Messages/Cooperative Awareness Messages and road environment sensor-perception data.

2. The system of claim 1, wherein the one or more processors are further programmed or configured to:
determine the ground truth velocity of an object-actor based on proceeding established run-time ground truth perception data in series.

3. The system of claim 1, wherein the one or more processors are further programmed or configured to:
determine the ground truth acceleration of an object-actor based on proceeding established run-time ground truth perception data in series.

4. The system of claim 1, wherein the one or more processors are further programmed or configured to:
construct labeled data for the post run training of machine learning models, wherein the run-time determined ground truth perception data and the raw data from the system's one or more sensors are logged and timestamped, wherein the logged and timestamped ground truth perception data generated at run-time comprises labeled features associated to the logged sensor data.

5. A method comprising:
receiving data associated with road environment object-actor sensor based detection and classification predictions and IEEE 1609 standard Security Credential Management System (SCMS) cryptographically signed SAE J2735 standard Basic Safety Messages (BSM) and/or Cooperative Awareness Messages (CAM); and
determining run-time ground truth perception based on reconciled and matched data artifacts constructed in a system relative coordinate reference map associated from BSM/CAM reported object-actor data and predicted object-actors data artifacts,
wherein the determining run-time ground truth perception further comprises:
extracting object-actor associated data in the received SCMS cryptographically signed SAE J2735 participant broadcasted Basic Safety Messages/Cooperative Awareness Messages from which an object-actor's pose is determined, wherein the received data includes but is not limited to of a reported object-actor's real-time kinematic GNSS corrected position, spatial dimensions, including a length, a width, and/or a height, and the categorical-type classification of the object-actor, wherein the BSM/CAM extracted data is transformed into a format to store and retrieve the represented object-actor as an artifact within a system relative coordinate reference map;
constructing representative object-actor artifacts within a system relative coordinate reference map, wherein a coordinate system comprises a data structure wherein persistent and/or temporary data representing road environment features and object-actors are related to the host base system in a format of normalized reference units of measure related to the sensing system's current position and/or a frame of reference, wherein the object-actors represented in the reference map are data artifacts generated from either sensor based predicted perception associated output data or from BSM/CAM based message data which contain position and occupancy attributes normalized with respect to the base system reference coordinate system, wherein in addition to the object-actor artifacts applicable a priori and/or run-time mapped and sensed road environmental features are also represented;
predicting object-actors present within the fields of view of the one or more sensors of the system; wherein the output of prediction comprises predicted presence of object-actors and respective classification and position state associated with sensor data, wherein the received sensor data is associated with one or more camera, LIDAR, or RADAR sensor, and wherein the prediction is based on the output of one or more machine learning models that predict the presence, position, category-type, and geometric dimensions of an object-actor, wherein the predicted object-actor output is sent to the system relative coordinate reference map as an predicted object-actor artifact;
determining the existence of two or more artifacts loaded in the system relative coordinate reference map that correspond to the same object-actor in the road environment, where a minimum of one of the two more artifacts is associated with BSM/CAM data upon which one or more algorithms and or machine learning models establishes the existence of a match between two or more object-actor representative artifacts,
wherein a matched set of artifacts constitutes a ground truth object-actor in the system reference map, when no sensor associated object-actor artifacts are identified as a match to a BSM/CAM artifact an unmatched BSM/CAM is the basis for constituting a ground truth perception object-actor, wherein after the determined ground truth object-actor artifact is constructed the precursor artifacts used to make the match are removed from the reference map, the outcome of the matched artifacts and map update is run-time ground truth perception, wherein the system relative coordinate reference map updates to reflect the outcome state for subsequent system runtime use and/or external transmission of ground truth data; and
persisting the matched object-actors artifacts as ground truth object-actor data artifacts in the system relative coordinate map which subsequently are logged with the associated data as cross-matched and reconciled data associated with Basic Safety Messages/Cooperative Awareness Messages and road environment sensor-perception data.

6. The method of claim 5, further comprising:
determining the ground truth velocity of an object-actor based on proceeding established run-time ground truth perception data in series.

7. The method of claim 5, further comprising:
determining the ground truth acceleration of an object-actor based on proceeding established run-time ground truth perception data in series.

8. The method of claim 5, further comprising:
constructing labeled data for the post run training of machine learning models, wherein the run-time determined ground truth perception data and the raw data from the system's one or more sensors are logged and timestamped, wherein the logged and timestamped ground truth perception data generated at run-time comprises labeled features associated to the logged sensor data.

9. At least one non-transitory computer readable medium storing at least one computer program product that comprises one or more instructions that cause at least one processor to perform operations, comprising:
receiving data associated with road environment object-actor sensor based detection and classification predictions and IEEE 1609 standard Security Credential Management System (SCMS) cryptographically signed SAE J2735 standard Basic Safety Messages (BSM) and/or Cooperative Awareness Messages (CAM); and
determining run-time ground truth perception based on reconciled and matched data artifacts constructed in a system relative coordinate reference map associated from BSM/CAM reported object-actor data and predicted object-actors data artifacts,
wherein the determining run-time ground truth perception further comprises:
extracting object-actor associated data in the received SCMS cryptographically signed SAE J2735 participant broadcasted Basic Safety Messages/Cooperative Awareness Messages from which an object-actor's pose is determined, wherein the received data includes but is not limited to of a reported object-actor's real-time kinematic GNSS corrected position, spatial dimensions, including a length, a width, and/or a height, and the categorical-type classification of the object-actor, wherein the BSM/CAM extracted data is transformed into a format to store and retrieve the represented object-actor as an artifact within a system relative coordinate reference map;
constructing representative object-actor artifacts within a system relative coordinate reference map, wherein a coordinate system comprises a data structure wherein persistent and/or temporary data representing road environment features and object-actors are related to the host base system in a format of normalized reference units of measure related to the sensing system's current position and/or a frame of reference, wherein the object-actors represented in the reference map are data artifacts generated from either sensor based predicted perception associated output data or from BSM/CAM based message data which contain position and occupancy attributes normalized with respect to the base system reference coordinate system, wherein in addition to the object-actor artifacts applicable a priori and/or run-time mapped and sensed road environmental features are also represented;
predicting object-actors present within the fields of view of the one or more sensors of the system; wherein the output of prediction comprises predicted presence of object-actors and respective classification and position state associated with sensor data, wherein the received sensor data is associated with one or more camera, LIDAR, or RADAR sensor, and wherein the prediction is based on the output of one or more machine learning models that predict the presence, position, category-type, and geometric dimensions of an object-actor, wherein the predicted object-actor output is sent to the system relative coordinate reference map as an predicted object-actor artifact;
determining the existence of two or more artifacts loaded in the system relative coordinate reference map that correspond to the same object-actor in the road environment, where a minimum of one of the two more artifacts is associated with BSM/CAM data upon which one or more algorithms and or machine learning models establishes the existence of a match between two or more object-actor representative artifacts,
wherein a matched set of artifacts constitutes a ground truth object-actor in the system reference map, when no sensor associated object-actor artifacts are identified as a match to a BSM/CAM artifact an unmatched BSM/CAM is the basis for constituting a ground truth perception object-actor, wherein after the determined ground truth object-actor artifact is constructed the precursor artifacts used to make the match are removed from the reference map, the outcome of the matched artifacts and map update is run-time ground truth perception, wherein the system relative coordinate reference map updates to reflect the outcome state for subsequent system runtime use and/or external transmission of ground truth data; and
persisting the matched pair of object-actors artifacts as stored in the system relative coordinate map which subsequently are stored in a matched, unified manner based on the combined associated data as cross-matched and reconciled data associated with Basic Safety Messages/Cooperative Awareness Messages and road environment sensor-perception data.

10. The at least one non-transitory computer readable medium of claim 9, wherein the one or more instructions that cause the at least one processor to determine run-time ground truth perception cause the at least one process to perform operations comprising:
determining the ground truth velocity of an object-actor based on proceeding established run-time ground truth perception data in series.

11. The at least one non-transitory computer readable medium of claim 9, wherein the one or more instructions that cause the at least one processor to determine run-time ground truth perception cause the at least one process to perform operations comprising:
determining the ground truth acceleration of an object-actor based on proceeding established run-time ground truth perception data in series.

12. The at least one non-transitory computer readable medium of claim 9, wherein the one or more instructions that cause the at least one processor to determine run-time ground truth perception cause the at least one process to perform operations comprising:
constructing labeled data for the post run training of machine learning models, wherein the run-time determined ground truth perception data and the raw data from the system's one or more sensors are logged and timestamped, wherein the logged and timestamped ground truth perception data generated at run-time comprises labeled features associated to the logged sensor data.
